(19) United States
(12) Patent Application Publication
(10) Pub. No.: US 2004/0026177 A1
(43) Pub. Date: Feb. 12, 2004

(54) Elevator

(76) Inventors: Hideki Ayano, Hitachi (JP); Hiromi Inaba, Hitachinaka (JP); Ikuo Yamato, Hitachi (JP); Shota Iwakura, Niihari-gun (JP); Taichi Maeda, Niihari-gun (JP); Akihiro Omiya, Hitachinaka (JP); Shinichirou Kawano, Okegawa (JP)

Correspondence Address: DICKSTEIN SHAPIRO MORIN & OSHINSKY LLP, 2101 L STREET NW, WASHINGTON, DC, 20037-1526, US

(21) Appl. No.: 10/359,240

(22) Filed: Feb. 6, 2003

(30) Foreign Application Priority Data
Aug. 8, 2002 (JP) 2002-231286

(51) Int. Cl. B66B 1/28

(52) U.S. Cl. 187/247

(57) ABSTRACT

An elevator is capable of transmitting signals between an elevator control unit and a car control unit without using tail cords. Resin-coated ropes for suspending an elevator car and a counterweight comprise conductive metal wires. Transmitter-receivers use the conductive metal wires of the ropes for contactless signal transmission. The conductive metal wires of the two ropes are connected in rope-anchoring parts to form an electrical closed loop for signal transmission.

### BACKGROUND OF THE INVENTION

The present invention relates to improvements in an elevator having a communication system for exchanging signals between a control unit and an elevator car in an elevator shaft.

A conventional elevator uses tail cords for exchanging signals between a control unit and an elevator car in an elevator shaft and for supplying power to illuminating devices for illuminating the interior of the elevator car, an air conditioner for air-conditioning the elevator car and a control panel placed in the elevator car. The length and weight of the tail cords increase with the increase of the height of the building and the diameter of the tail cords increases to reduce copper loss. Consequently, it is possible that the tail cords cause the elevator car to swing and an offset load to be placed on the elevator car. Tail cords spoil the aesthetic design of an observation elevator having a glass shaft and a glass elevator car. Thus, demand for signal transmission without using tail cords has progressively grown.

A signal transmission method 1 disclosed in Japanese Patent Laid-open No. 9-202550 supplies power and signals to a steel-wire rope to transmit signals by electromagnetic induction. Signal transmission methods 2 and 3 disclosed in Japanese Patent Laid-open No. 11-79574 and Japanese Patent Laid-open No. 2001-270671 use signal lines incorporated in ropes for signal transmission. The signal transmission method 3 uses resin-coated ropes as well as steel-wire ropes.

Since the prior art signals transmission method 1 uses the steel-wire rope for supplying current, the current flows through the shaft of a motor included in a hoist gear and hence it is possible that bearings of the motor is corroded. Since the steel-wire rope has one end grounded through a rail installed in the elevator shaft and the other end grounded through sheaves and pulleys, the steel-wire rope forms a closed electric loop. Since the rail has a large impedance and the closed electric loop is formed by metal parts installed in the elevator shaft, complicated electric paths are formed, and the electric paths are susceptible to noise and may possibly affect adversely to signal transmission.

The prior art signal transmission methods 2 and 3 connect the elevator car and the control unit by signal lines incorporated into the rope. Therefore, the rope must have one end connected to the elevator car and the other end connected to the control unit. Thus, the signal transmission methods 2 and 3 are applicable to only elevators of a special roping system. It is very difficult to manufacture the rope combined with the signal lines, it is possible that the signal lines are broken when the rope is elongated, and it is possible that stable signal transmission cannot be achieved.

### SUMMARY OF THE INVENTION

Accordingly, it is an object of the present invention to provide an elevator not needing any tail cords and capable of information communication in an elevator shaft.

Another object of the present invention is to provide an elevator capable of exchanging signals with external devices scarcely affecting the external devices by noise and scarcely being affected by noise.

A third object of the present invention is to provide an elevator not needing modifications, such as incorporating special signal lines in ropes, not placing any restrictions on a roping system, and enabling information communication in an elevator shaft.

According to one aspect of the present invention, an elevator that transmits and receives signals through the conductive metal wires of a rope is provided with insulating means for electrically insulating the conductive metal wires of the rope from conductive parts of sheaves and pulleys.

Desirably, the insulating means coats the conductive metal wires of the rope with insulating material, such as a resin, or forms insulating contact parts with which the rope engages in the sheaves and pulleys. Thus, any leakage current does not flow into motors and such even if signal currents are supplied to the metal wires of the rope, and signals can be transmitted, scarcely being affected by external noise.

According to a second aspect of the present invention, an elevator includes an electrical wire-connecting means for electrically connecting the conductive metal wires of first and second ropes at one end of the first rope and one end of the second rope, or at both ends of the first and the second rope, wherein an electrical closed loop is formed by the two ropes, electrical wire-connecting means and/or the input-output unit of a transmitter-receiver, and the conductive metal wires are coated with an insulating material.

Desirably, the electrical wire-connecting means for electrically connecting the conductive metal wires of the first and the second rope includes two connectors electrically connected to the conductive metal wires of the first and the second rope at the corresponding ends of the first and the second rope and capable of being coupled together, or a bend in a single rope formed by bending the rope in two ropes. Thus, an electrical loop for transmitting electric signals can be formed only of the ropes by electrically connecting the metal wires of the two ropes at the ends of the ropes. Signals flow only through the ropes to reduce the possibility of affecting external devices by noise and of being affected by noise. Any modification, such as incorporating special signal lines in the ropes, is unnecessary, and there is no restrictions on the roping system.

According to a third aspect of the present invention, at least one of transmitter-receivers is provided with a coupling means, such as a transformer or a Hall element, disposed opposite to and apart from the conductive metal wires of the rope for the electromagnetic coupling of the transmitter-receiver and the metal wires.

The transmitter-receiver does not need to be mechanically connected to the metal wires, and signals are exchanged in a noncontact mode using an electromagnetic field.

### BRIEF DESCRIPTION OF THE DRAWINGS

The above and other objects, features and advantages of the present invention will become more apparent from the following description taken in connection with the accompanying drawings, in which:

FIG. 1 is a schematic perspective view of an elevator in a first embodiment according to the present invention;

FIG. 2 is an enlarged sectional view of a resin-coated rope;

FIG. 3 is an enlarged view of a wire-connecting arrangement for connecting the metal wires of ropes at a rope-anchoring part of the elevator shown in FIG. 1;

FIG. 4 is an enlarged view of another wire-connecting arrangement for connecting the metal wires of ropes at the rope-anchoring part of the elevator shown in FIG. 1;

FIG. 5 is an enlarged view of a third wire-connecting arrangement for connecting the metal wires of ropes at the rope-anchoring part of the elevator shown in FIG. 1;

FIG. 6 is a perspective view of assistance in explaining a connecting method of connecting metal wires at the rope-anchoring part of the elevator shown in FIG. 1;

FIG. 7 is a perspective view of assistance in explaining another connecting method of connecting metal wires at the rope-anchoring part of the elevator shown in FIG. 1;

FIG. 8 is a perspective view of assistance in explaining a connecting method of connecting metal wires at the rope-anchoring part of the elevator shown in FIG. 1 when resin-coated flat ropes are used;

FIG. 9 is a perspective view of assistance in explaining another connecting method of connecting metal wires at the rope-anchoring part of the elevator shown in FIG. 1 when resin-coated flat ropes are used;

FIG. 10 is a schematic perspective view of a transmitter-receiver for signal transmission applicable to the elevator shown in FIG. 1;

FIG. 11 is a schematic perspective view of another transmitter-receiver for signal transmission applicable to the elevator shown in FIG. 1;

FIG. 12 is a schematic view of assistance in explaining the disposition the transmitter-receiver in the elevator shown in FIG. 1;

FIG. 13 is a view taken in the direction of the arrow A in FIG. 12;

FIG. 14 is a view taken in the direction of the arrow B in FIG. 12;

FIG. 15 is a perspective view of a pulley;

FIG. 16 is a schematic view of assistance in explaining a first possible position for the transmitter-receiver for signal transmission;

FIG. 17 is a schematic view of assistance in explaining a second possible position for the transmitter-receiver for signal transmission;

FIG. 18 is a schematic view of assistance in explaining a third possible position for the transmitter-receiver for signal transmission;

FIG. 19 is a schematic perspective view of an elevator in a second embodiment according to the present invention;

FIG. 20 is a schematic perspective view of an elevator in a third embodiment according to the present invention;

FIG. 21 is a typical view of assistance in explaining an insulating means for an elevator according to the present invention for insulating metal-wire ropes from a pulley; and

FIG. 22 is a view of an insulating structure incorporated into a rope-anchoring part disposed in a top part of an elevator shaft included in an elevator according to the present invention.

### DESCRIPTION OF THE PREFERRED EMBODIMENTS

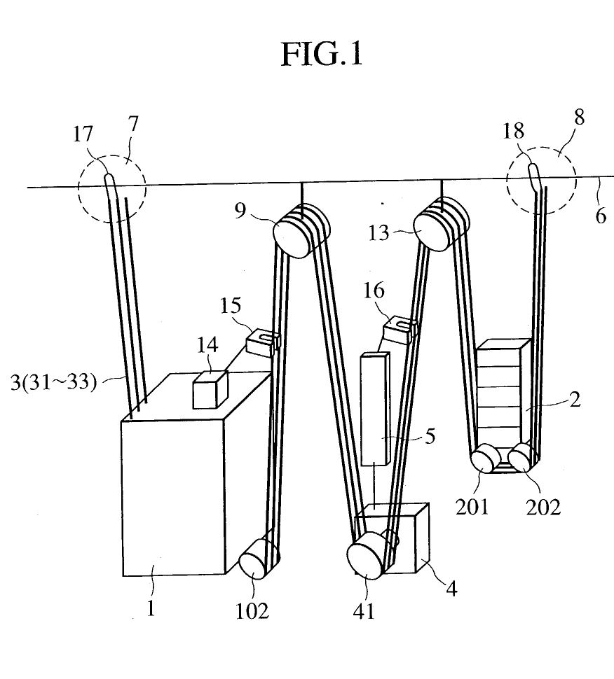

Referring to FIG. 1 showing an elevator in a first embodiment according to the present invention, an elevator car 1 and a counterweight 2 are suspended by resin-coated ropes 31, 32 and 33 (sometimes indicated inclusively at 3) forming a two-to-one roping system so as to counterbalance each other. The resin-coated ropes 3 are wound round two pulleys 101, 102 (only one of the two pulleys 102 is shown) supported on the elevator car 1, and two pulleys 201 supported on the counterweight 2. A motor 4 is disposed below a middle part of the roping system. A drive sheave 41 is mounted on the output shaft of the motor 4. The motor 4 drives the rope system including the resin-coated ropes 3, the elevator car 1 and the counterweight 2 through the drive sheave 41. An elevator control unit 5 controls the operation of the motor 4. Opposite ends of each of the resin-coated ropes 3 are held fixedly by rope-anchoring parts 7 and 8 attached to a top structure 6 disposed at the top of an elevator shaft. Since the motor 4 is disposed in a lower part of the elevator shaft, fixed pulleys 9 and 13 are suspended from the top structure 6 to invert the moving direction of the resin-coated ropes 3.

The elevator car is provided with a car control unit 14 for controlling the equipment of the elevator car 1. Information about the present position of the elevator car 1 and signals including call signals needs to be exchanged between the elevator control unit 5 and the car control unit 14. The elevator car 1 and the elevator control unit 5 are provided with transmitter-receivers (coupling means) 15 and 16, respectively. The transmitter-receivers 15 and 16 are disposed opposite to the conductive metal wires (hereinafter referred to simply as “metal wires”) of the resin-coated rope 3 for contactless signal transmission and reception. The metal wires of the two resin-coated ropes 3 are connected electrically by connecting wires (connecting means) 17 and 18 at the rope-anchoring parts 7 and 8 to form an electrical closed loop by the metal wires of the two resin-coated ropes 3. The metal wires of the resin-coated rope 3 and the transmitter-receivers 15 and 16 exchange signals in a contactless transmission mode using electromagnetic fields. Power is supplied to the equipment of the elevator car 1 by a contactless power feed method or a trolley power feed method.

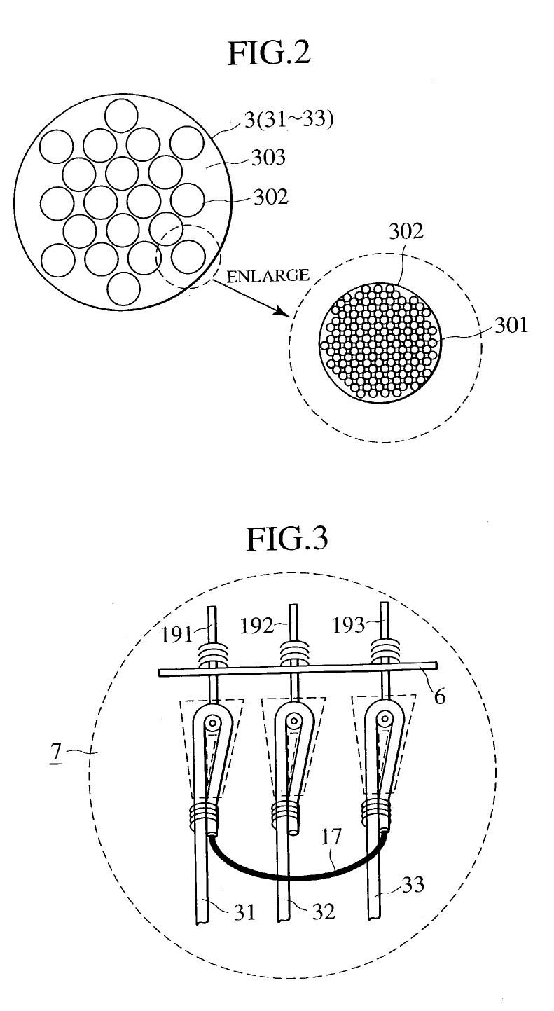

Referring to FIG. 2 showing one of the resin-coated ropes 3 in a sectional view, the resin-coated rope 3 is formed by bundling a plurality of schenkels 302 each formed by bundling strands 301 of fine metal wires, and coating the bundle of the schenkels 302 with a resin coating (insulating means) 303. The fine wires of the resin-coated rope 3 are of high-tension steel wires and hence the resin-coated rope 3 is lightweight as compared with a corresponding steel-wire rope. Although the drive sheave 41 mounted on the output shaft of the motor 4, the fixed pulleys 9 and 13, and the car pulleys 102 have comparatively small diameters, friction between the resin coating of the resin-coated rope 3 and the sheave 41 and the pulleys 9, 13 and 102 is comparatively high. Therefore, the motor 4 may be a small one, and the resin-coated ropes 3 have a long service life. Since the resin coating 303 isolates the strands 301 of the resin-coated rope 3 from external matters, any leakage current does not flow through the sheave 41 and the motor 4 and hence the insulator of the motor 4 is not deteriorated when current flows through the strands 301.

FIG. 3 shows, in an enlarged view, a wire-connecting arrangement at the rope-anchoring part 7 of the elevator shown in FIG. 1. Standard elevators are provided with a plurality of ropes. The elevator shown in FIG. 1 is provided with the three resin-coated ropes 31, 32 and 33. End parts of the resin-coated ropes 31, 32 and 33 are hooked on suspension rods 191, 192 and 193 held on the top structure 6 of the elevator shaft. End parts of the strands 301 of the two resin-coated ropes 31 and 33 are connected by the connecting wire 17. Similarly, the other end parts of the strands 301 of the resin-coated ropes 31 and 33 are connected by the connecting wire 18. Thus, an electrical closed loop is formed by the resin-coated ropes 31 and 33. Since the resin coatings 303 of the resin-coated ropes 3 are electrically insulating, any trouble does not occur in signal transmission even if the resin-coated ropes 3 come into contact with each other. Since the resin-coated ropes 3 are not electrically connected through the sheave 41 and the pulleys 9 and 13 to the motor 4 and external grounds, the resin-coated ropes 3 are able to exercise satisfactory signal transmission characteristics.

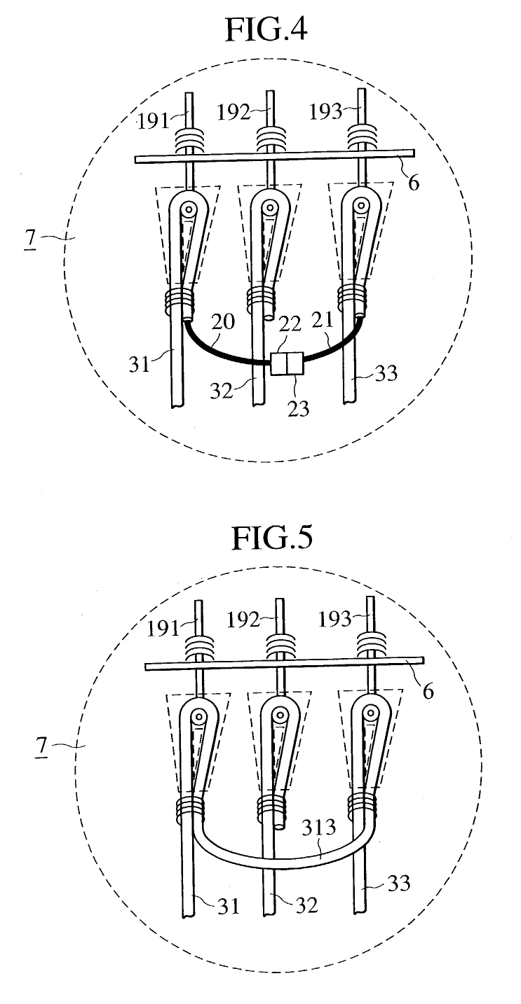

Referring to FIG. 4 showing another wire-connecting arrangement in the rope-anchoring part 7 of the elevator shown in FIG. 1, connecting lines 20 and 21 have end parts connected to the strands of the resin-coated ropes 31 and 33, and the other end parts provided with connectors (connecting means) 22 and 23, respectively. The connectors 22 and 23 are connected for the normal operation of the elevator. The connectors 22 and 23 are disconnected to facilitate elevator-installing work and maintenance work.

Referring to FIG. 5 showing a third wire-connecting arrangement in the rope-anchoring part 7 of the elevator shown in FIG. 1, the resin-coated ropes 31 and 33 are segments of a single resin-coated rope on the opposite sides of a bend 313. Since the single resin-coated rope forms an electrical closed loop, any connecting devices for connecting two resin-coated ropes are not necessary, and signals can be transmitted very stably.

As best shown in FIG. 1, the resin-coated ropes 3 have opposite ends held fixedly by the rope-anchoring parts 7 and 8, and it is very difficult to manufacture and install a rope that can be fixedly held by both the rope-anchoring parts 7 and 8 by the wire-connecting arrangement shown in FIG. 5. Therefore, it is desirable to use the wire-connecting arrangement shown in FIG. 5 at one of the rope-anchoring parts 7 and 8 and to use the wire-connecting arrangement shown in FIG. 3 or 4 at the other. Work, such as maintenance work, around the rope-anchoring part 7 on the side of the elevator car 1 is easier than that around the rope-anchoring part 8 on the side of the counterweight 7 after the installation of the elevator. Therefore, it is desirable to use the wire-connecting arrangement shown in FIG. 3 or 4 at the rope-anchoring part 7 on the side of the elevator car 1 and to use the wire-connecting arrangement shown in FIG. 5 at the rope-anchoring part 8 on the side of the counterweight 2.

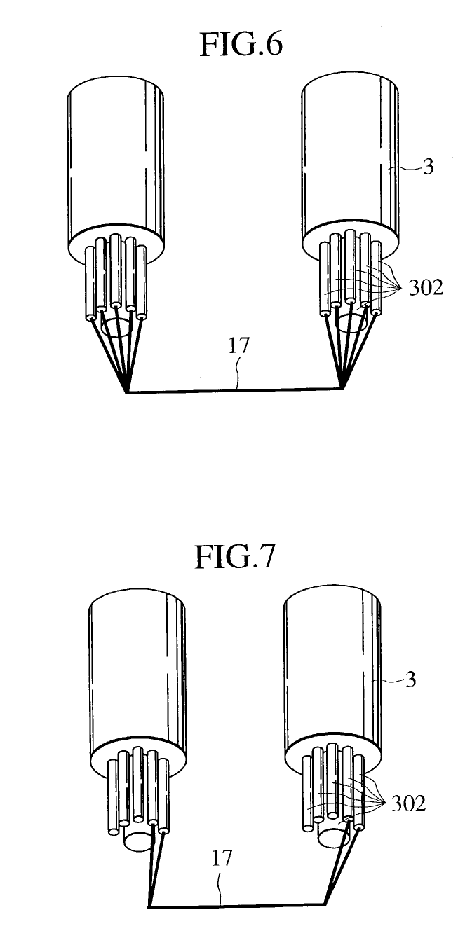

FIG. 6 is a typical perspective view of assistance in explaining a connecting method of connecting metal wires at the rope-anchoring part 7 of the elevator shown in FIG. 1. As mentioned above in connection with FIG. 2, the resin-coated rope 3 is formed by bundling the plurality of schenkels 302 each formed by bundling the strands 301 of fine metal wires, and coating the bundle of the schenkels 302 with the resin coating 303. Spaces between the schenkels 302 are filled up with the resin forming the resin coating 303. Therefore, the resin-coated rope 3 has high frictional property. Since the strands 301 forming the schenkels 302 are formed of a metal, such as a steel or copper, the resin-coated rope 3 has a high electrical conductivity. In FIG. 6, all the schenkels 302 of the resin-coated ropes are connected by the connecting wire 17 to use all the schenkels 302 for signal transmission. Thus, even if one or some of the schenkels 302 is broken, signals can be transmitted without any trouble.

FIG. 7 is a typical perspective view of assistance in explaining another connecting method of connecting metal wires at the rope-anchoring part 7 of the elevator shown in FIG. 1. This connecting method connects only some of the schenkels 302. Considerable heat is generated in the schenkels 302 when current flows through the schenkels 302, and it is possible that the heated schenkels are deteriorated more rapidly than the not heated schenkels. Therefore, only some of the schenkels 302 are used for signal transmission as shown in FIG. 7 and the rest are not used for signal transmission to suppress the reduction of the strength of the resin-coated rope 3 due to the deterioration of the schenkels 302 used for signal transmission.

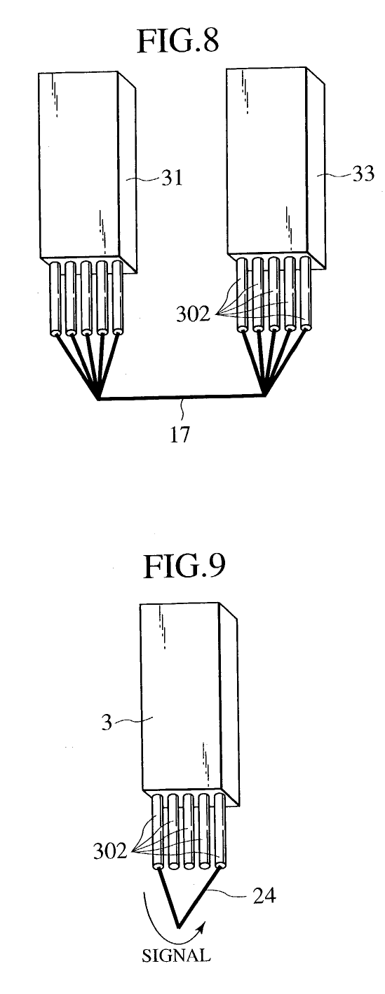

FIG. 8 is a perspective view of assistance in explaining a connecting method of connecting metal wires at the rope-anchoring part 7 of the elevator shown in FIG. 1 when resin-coated flat ropes are used. A flat rope is made by arranging strands 301 or schenkels 302 formed by bundling strands 301 in a plane, and coating the planar arrangement of the strands 301 or the schenkels 302 with a resin coating 303. Flat ropes 31 and 33 shown in FIG. 8 are formed by arranging schenkels 302 in a plane and coating the planar arrangement of the schenkels 302 with a resin coating. All the schenkels 302 of the flat ropes 31 and 33 are connected by a connecting wire 17 to use the same for signal transmission. The effect of the connecting method illustrated in FIG. 8 is the same as that of the connecting method illustrated in FIG. 6.

FIG. 9 is a perspective view of assistance in explaining another connecting method of connecting metal wires at the rope-anchoring part 7 of the elevator shown in FIG. 1 when resin-coated flat ropes are used. A plurality of schenkels 302 of a resin-coated flat rope 3 are electrically insulated from each other. An electrical closed loop can be formed by only the single resin-coated flat rope 3, for example, by connecting the schenkels 302 extending along the opposite sides of the resin-coated flat rope 3 by a connecting wire 24.

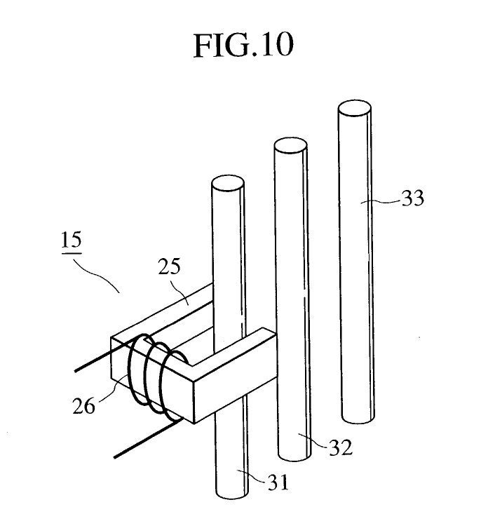

FIG. 10 shows a transmitter-receiver 15 for signal transmission applicable to the elevator shown in FIG. 1. The transmitter-receiver 15 has a coil 26 wound on a C-shaped magnetic core 25. The transmitter-receiver 15 and the resin-coated rope 31 are linked by a magnetic field to form an electric device having the characteristics of a transformer. Thus, contactless signal transmission from the transmitter-receiver 15 to the resin-coated rope 31 is possible. A standard elevator employs the c-shaped magnetic core 25 to facilitate installing the transmitter-receiver 15 because the ropes of such a standard elevator are extended at intervals of several millimeters. The outermost resin-coated rope 31 is used for signal transmission to facilitate the installation of the transmitter-receiver 15.

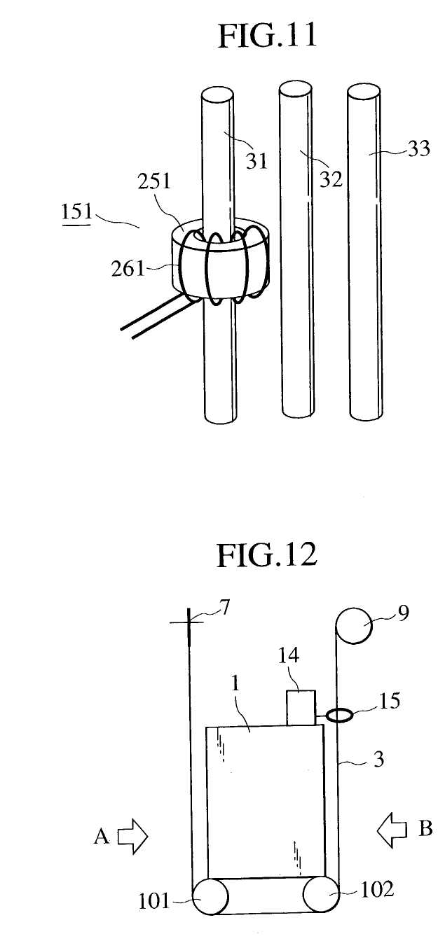

FIG. 11 shows another transmitter-receiver 151 for signal transmission applicable to the elevator shown in FIG. 1. The transmitter-receiver 151 has a coil 261 wound on a toroidal magnetic core 251. The transmitter-receiver 151 is based on the same principle as the transmitter-receiver 15 shown in FIG. 10. The toroidal magnetic core 251 has a low magnetic reluctance, which enables accurate signal transmission and reception.

Although the transmitter-receivers shown in FIGS. 10 and 11 are provided with the magnetic cores, any suitable transmitter-receiver based on any principle may be used provided that the transmitter-receiver is capable of exchanging signals with conductive wires in a contactless transmission mode. A transmitter and a receiver may be used instead of a transmitter-receiver. The receiver may be a device capable of contactless signal transmission, such as a Hole element or a transformer.

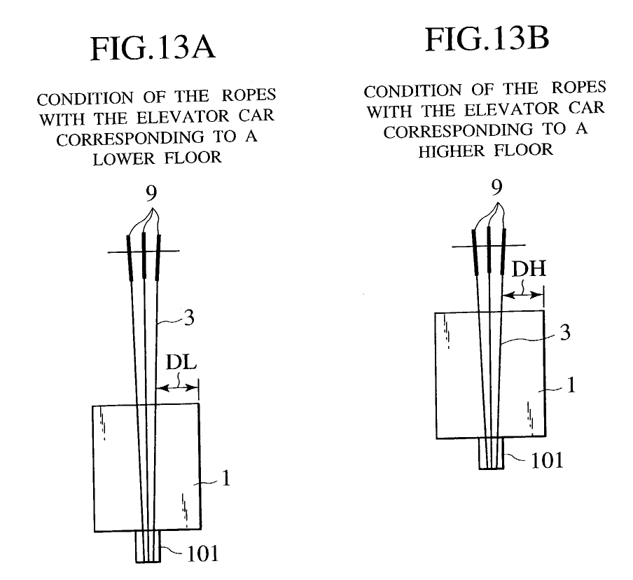

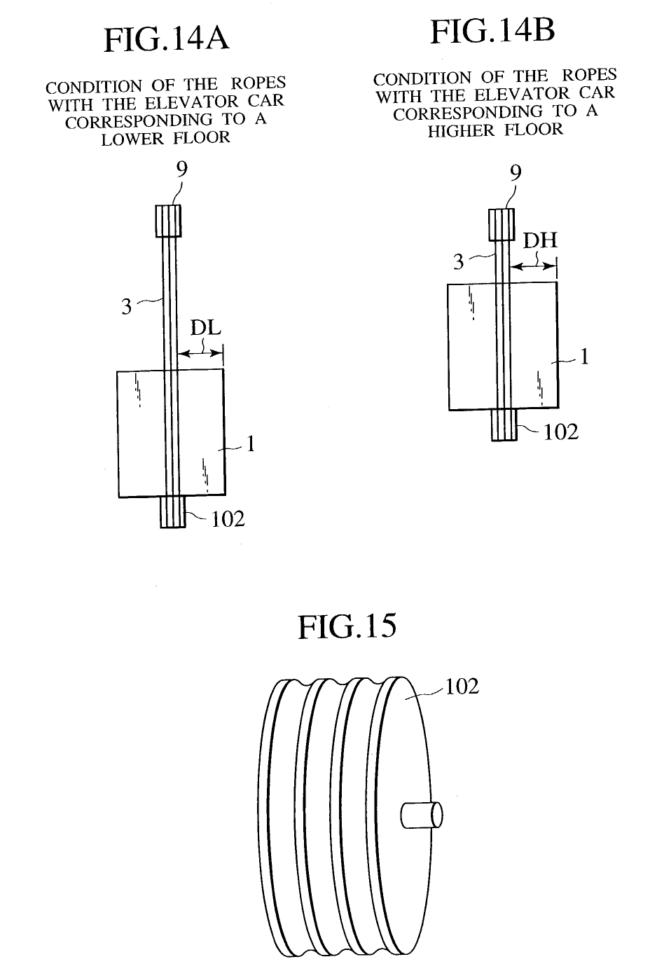

FIG. 12 is a schematic view of assistance in explaining the disposition of the transmitter-receiver 15 in the elevator shown in FIG. 1. The transmitter-receiver 15 is disposed at a position above the elevator car 1 and between the fixed pulley 9 and the car pulleys 102. The transmitter-receiver 15 may be disposed either at a first position above the elevator car 1 and between the fixed pulley 9 and the car pulley 102 or at a second position above the elevator car 1 and between the rope-anchoring part 7 and the car pulley 101. The effect of the first position and that of the second position are greatly different from each other, which will be described with reference to FIGS. 13 and 14.

FIGS. 13A and 13B are views taken in the direction of the arrow A in FIG. 12. FIG. 13A shows the elevator car 1 at a position corresponding to a lower floor, and FIG. 13B shows the elevator car 1 at a position corresponding to a higher floor. The rope-anchoring part 7 holds the resin-coated ropes 3 at comparatively wide intervals to facilitate maintenance work for adjusting the resin-coated ropes 3. Therefore, the distance DL between a side surface of the elevator car 1 and the outermost resin-coated roper 3 when the elevator car 1 is at the position shown in FIG. 13A is greater than the distance DH between the same side surface of the elevator car 1 and the same resin-coated roper 3 when the elevator car 1 is at the position shown in FIG. 13B, i.e., DL>DH. As obvious from FIGS. 13A and 13B, the inclination of the outermost resin-coated rope 3 to a vertical plane increases as the elevator car 1 moves up from a position corresponding to a lower floor toward a position corresponding to a higher floor. Consequently, when the transmitter-receiver shown in FIG. 10 or 11 is used, the positional relation between the transmitter-receiver and the resin-coated rope 3 varies according to the position of the elevator car 1 and hence it is difficult to dispose the transmitter-receiver so that resin-coated rope 3 may not come into contact with the transmitter-receiver and accurate signal transmission and reception can be achieved.

FIGS. 14A and 14B are views taken in the direction of the arrow A in FIG. 12. FIG. 14A shows the elevator car 1 at a position corresponding to a lower floor, and FIG. 14B shows the elevator car 1 at a position corresponding to a higher floor. The fixed pulley 9 guides the resin-coated ropes 3 at comparatively narrow intervals equal to those at which the car pulley 102 guides the resin-coated ropes 3. Therefore, the distance DL between a side surface of the elevator car 1 and the outermost resin-coated roper 3 when the elevator car 1 is at the position shown in FIG. 14A is approximately equal to the distance DH between the same side surface of the elevator car 1 and the same resin-coated roper 3 when the elevator car 1 is at the position shown in FIG. 14B, i.e., DL=DH. As obvious from FIGS. 14A and 14B, the positions of the resin-coated ropes 3 extending between the fixed pulley 9 and the car pulley 102 relative to the elevator car remain substantially unchanged regardless of the position of the elevator car 1.

FIG. 15 shows the car pulley 102. The rest of the pulleys are substantially the same as the car pulley 102. Each of those pulleys is provided with circumferential grooves as shown in FIG. 15. The pulleys are centered accurately when the elevator is installed so that the resin-coated ropes 3 are guided correctly. Consequently, the positional relation between the transmitter-receiver 15 disposed between the fixed pulley 9 and the car pulley 102 as shown in FIG. 12 and the resin-coated rope 3 is fixed, and hence the transmitter-receiver 15 is always able to exhibit stable signal transmitting and receiving abilities. Naturally, the transmitter-receiver 15 may be disposed as shown in FIG. 12 when the car pulley 102 is held on a top part of the elevator car 1 instead of on a bottom part of the elevator car 1 as shown in FIG. 12.

Similarly, the positional relation between the transmitter-receiver 16 disposed between the fixed pulley 13 and the sheave 41 mounted on the output shaft of the motor 4 as shown in FIG. 1 and the resin-coated rope 3 also can be fixed, and hence the transmitter-receiver 16 is always able to exhibit stable signal transmitting and receiving abilities. It is desirable to avoid disposing the transmitter-receivers 15 and 16 at positions in regions around the rope-anchoring parts 7 and 8 in which the position of the resin-coated rope 3 is variable and to dispose at positions corresponding to parts between the accurately centered pulleys or sheaves provided with accurate grooves of the resin-coated rope 3.

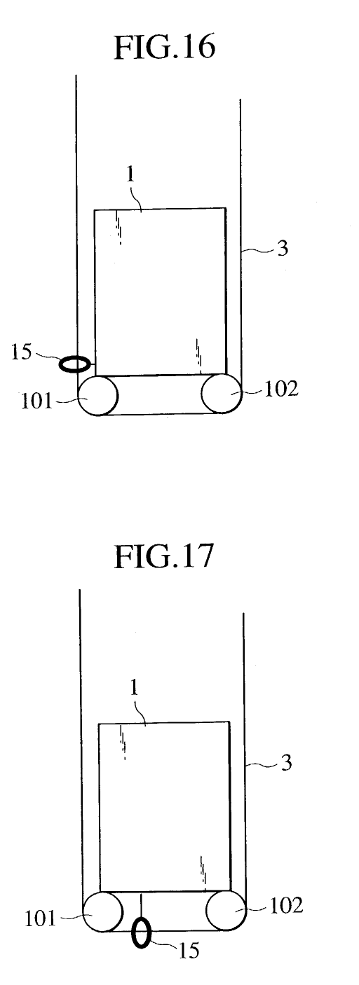

FIG. 16 a schematic view of assistance in explaining a first possible position for the transmitter-receiver 15. The transmitter-receiver 15 is disposed near the car pulley 101. Since the range of positional variation of the resin-coated rope 3 relative to the elevator car 1 previously explained in connection with FIGS. 13A and 13B is narrow in a region around the pulley or the sheave, the positional relation between the transmitter-receiver 15 and the resin-coated rope 3 can be stabilized by disposing the transmitter-receiver 15 in the region around the pulley or the sheave.

FIG. 17 a schematic view of assistance in explaining a second possible position for the transmitter-receiver 15. The transmitter-receiver 15 is disposed at a position under the elevator car 1 opposite to a part extending between the car pulleys 101 and 102 of the resin-coated rope 3. The position of the part extending between the car pulleys 101 and 102 of the resin-coated rope 3 changes scarcely, and hence the positional relation between the transmitter-receiver 15 and the resin-coated rope 3 is very stable.

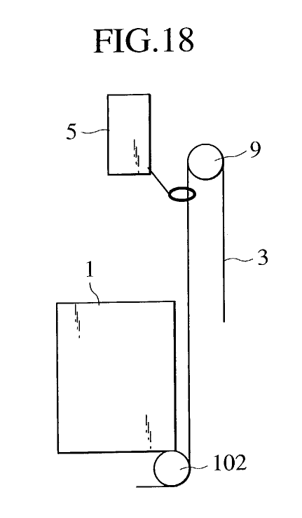

FIG. 18 a schematic view of assistance in explaining a third possible position for the transmitter-receiver 16 connected with the elevator control unit 5. The position of the transmitter-receiver 16 is between the fixed pulley 9 and the car pulley 102 and near the fixed pulley 9. Thus the positional relation between the resin-coated rope 3 and the transmitter-receiver 16 is stabilized.

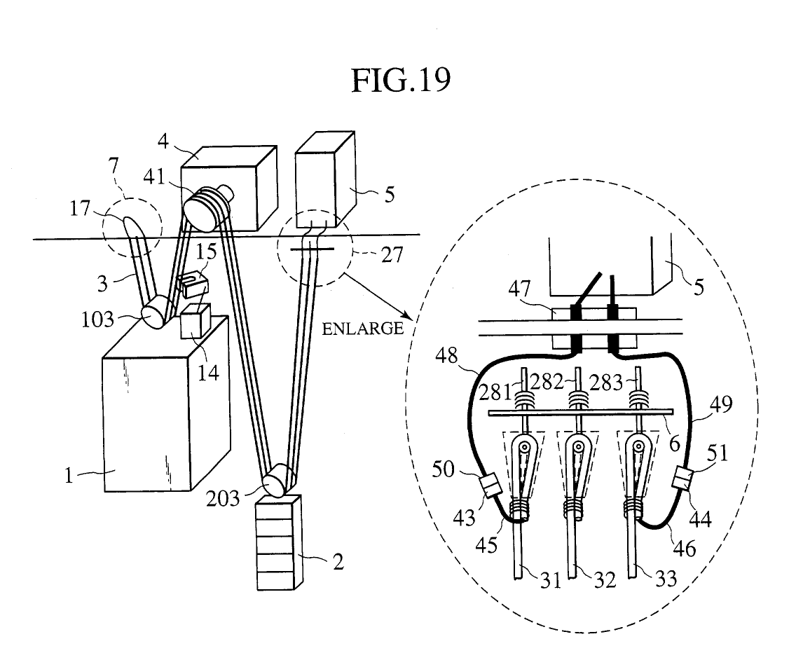

FIG. 19 is a schematic perspective view of an elevator in a second embodiment according to the present invention. In this elevator, a motor 4 is installed in an elevator machine room constructed on top of an elevator shaft. As shown in FIG. 19, an elevator car 1 and a counterweight 2 are suspended by resin-coated ropes 31, 32 and 33 (sometimes indicated inclusively at 3) forming a two-to-one roping system. Each of the resin-coated ropes 3 has one end held fixedly by a rope-anchoring part 7, and the other end held fixedly by a rope-anchoring part 27. The resin-coated ropes 3 are extended between the rope-anchoring parts 7 and 27 via a car pulley 103 supported on the elevator car 1, a sheave 41 mounted on the output shaft of the motor 4, and a pulley 203 supported on the counterweight 2. The metal wires of the two of the resin-coated ropes 3 are connected by a connecting wire 17 in the rope-anchoring part 7, and the metal wires of the same two resin-coated ropes 3 are connected to the signal I/O port of an elevator control unit 5 in the other rope-anchoring part 27. As shown in FIG. 19 in an enlarged view, the rope-anchoring part 27 suspends the resin-coated ropes 31, 32 and 33 by suspension rods 281, 282 and 283 held on a top structure 6 of the elevator shaft. Connecting wires 45 and 46 provided at their free ends with connectors 43 and 44 are connected to end parts of the metal wires of the resin-coated ropes 31 and 33, which serve for signal transmission, respectively. Connecting wires 48 and 49 provided at their free ends with connectors 50 and 51 are connected to terminals arranged on a terminal board 47. The connectors 43 and 44 are connected to the connectors 50 and 51, respectively, to connect a signal transmission line formed of the two resin-coated ropes 31 and 33 to the I/O port of the elevator control unit 5. Thus, an electrical, closed loop including the I/O port of the elevator control unit 5 is formed. This signal transmitting arrangement is more effective than the aforesaid contactless signal transmitting arrangement in reducing the influence of noise on the elevator control unit 5.

In the elevator shown in FIG. 19, in which the car pulley 103 is supported on the elevator car 1, a transmitter-receiver 15 may be disposed opposite to a part between the sheave 41 mounted on the output shaft of the motor 4 and the car pulley 103 of the resin-coated rope 3 or may be disposed close to the car pulley 103 to stabilize the positional relation between the resin-coated rope 3 and the transmitter-receiver 15.

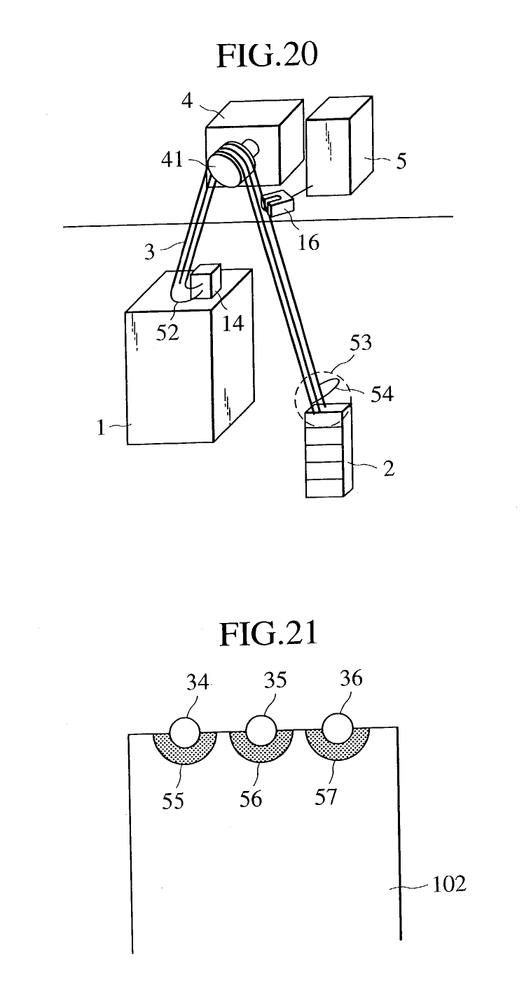

FIG. 20 is a schematic perspective view of an elevator in a third embodiment according to the present invention. In this elevator, a motor 4 is installed in an elevator machine room constructed on top of an elevator shaft. As shown in FIG. 20, an elevator car 1 and a counterweight 2 are suspended by resin-coated ropes 3 forming a one-to-one roping system. Metal wires of end parts of the resin-coated ropes 3 are connected to a car control unit 14 disposed on top of the elevator car 1 by connecting lines 52, and metal wires of the other end parts on the side of the counterweight 2 of the resin-coated ropes 3 to be used for signal transmission are connected (short-circuited) by a connecting wire 54 to form an electrical closed loop. This signal transmitting arrangement is more effective than the aforesaid contactless signal transmitting arrangement in reducing the influence of noise on the car control unit 14. In the elevator shown in FIG. 20, a transmitter-receiver 16 connected for signal transmission to an elevator control unit 5 is disposed near a sheave 41 mounted on the output shaft of the motor 4. Thus, the positional relation between the resin-coated rope 3 and the transmitter-receiver can be stabilized.

Although the elevators in the foregoing embodiments employ the resin-coated ropes for suspending the elevator car, ropes coated with an insulating material, such as rubber, may be used.

The ropes and the structural members arranged in the elevator shaft may be of any types, provided that the metal wires of the ropes are insulated from the structural members; that is, there is no particular restriction on the elevator provided that the metal wires of the ropes are electrically insulated from the sheaves and the pulleys.

FIG. 21 shows insulating means for an elevator according to the present invention for insulating metal-wire ropes from a pulley. As shown in FIG. 21, insulating rings 55, 56 and 57 (insulating means) are fitted in annular grooves formed in the side surface of a pulley 102 of a metal, such as cast iron, to insulate steel-wire ropes 34, 35 and 36 engaged in the annular grooves from the pulley 102. A rope-anchoring part on a top part of an elevator shaft should be also insulated.

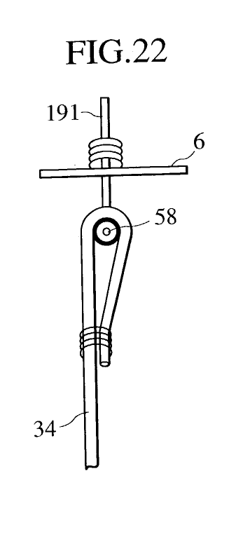

FIG. 22 shows insulating means incorporated into a rope-anchoring part disposed in a top part of an elevator shaft included in an elevator according to the present invention. One of steel-wire ropes 34, 35 and 36, i.e., a steel-wire rope 34, is shown in FIG. 22. An end part of the steel-wire rope 34 is hooked on a suspension rod 191 fixed to a top structure 6 of the elevator shaft. A lower part of the suspension rod 191 is covered with an insulating member (insulating means) 58 to insulate the suspension rod 191 from the steel-wire rope 34.

The steel-wire ropes 34, 35 and 36 shown in FIGS. 21 and 22 are used for signal transmission.

As apparent from the foregoing description, according to the present invention, the rope type elevator is capable of information communication in the elevator shaft without using any tail cords, and there is only little possibility for the elevator to exert noise on external devices and to be subject to external noise. In particular, as shown in FIGS. 19 and 20, the techniques used in the present invention are applicable in various manners irrespective of roping systems.

Although the invention has been described in its preferred embodiments, the present invention is not limited in its practical application to those embodiments and many changes and modifications are possible without departing from the scope and spirit thereof.

What is claimed is:

1. An elevator comprising:
ropes comprising conductive metal wires;
an elevator car suspended by the ropes for vertical movement in an elevator shaft;
a counterweight suspended by the ropes for vertical movement in the elevator shaft;
a sheave engaged with the ropes;
a motor for driving the sheave for rotation;
pulleys supported on upper and lower parts of the elevator shaft and on the elevator car to guide the ropes;
a control unit for controlling operation of the elevator car; and
two transmitter-receivers capable of transmitting and receiving signals through the conductive metal wires of the ropes;
wherein the conductive metal wires of the ropes are insulated from the sheave and the pulleys by insulating means.

2. The elevator according to claim 1, wherein the insulating means comprises an insulating material for coating the conductive metal wires of the rope.

3. The elevator according to claim 1, wherein some of the component conductive metal wires of the rope are used for signal transmission and reception.

4. The elevator according to claim 1, wherein the transmitter-receivers are disposed opposite to a part of the rope of the rope extending between the pulley supported on the elevator car and the pulley or the sheave held on a top part of the elevator shaft.

5. The elevator according to claim 1, wherein the transmitter-receivers are disposed opposite to a part of the rope extending between the pulley or the sheave placed in an upper part of the elevator shaft and the pulley or the sheave placed in a lower part of the elevator shaft.

6. The elevator according to claim 1, wherein the transmitter-receivers are disposed opposite to a part of the rope extending between the pulleys or the sheave placed in at least two of an upper part of the elevator shaft, a lower part of the elevator shaft and a part on the elevator car, the transmitter-receivers being disposed at positions near the pulleys or the sheave.

7. The elevator according to claim 1, wherein the pulleys or the sheave supported on the elevator car are disposed at two portions under a floor of the elevator car, and the transmitter-receiver on the side of the elevator car is disposed opposite to a part of the rope extending between the pulleys or the sheave supported under the floor of the elevator car.

8. The elevator according to claim 1, wherein the sheave and the pulleys are provided with insulating contact members capable of coming into contact with the ropes and of electrically insulating the sheave and the pulleys from the ropes.

9. The elevator according to claim 1, wherein at least one of the transmitter-receivers is a coupling means disposed opposite to the conductive metal wires of the rope for contactless signal exchange and capable of transmitting signals.

10. The elevator according to claim 9, wherein the transmitter-receivers are transformers electromagnetically coupled with the conductive metal wires of the rope, or Hole elements.

11. An elevator comprising:
ropes comprising conductive metal wires;
an elevator car suspended by the ropes for vertical movement in an elevator shaft;
a counterweight suspended by the ropes for vertical movement in the elevator shaft;
a sheave engaged with the ropes;
a motor for driving the sheave for rotation;
pulleys supported on upper and lower parts of the elevator shaft and on the elevator car to guide the ropes;
a control unit for controlling operation of the elevator car; and
two transmitter-receivers capable of transmitting and receiving signals through the conductive metal wires of the ropes;
wherein the conductive metal wires of the ropes are connected electrically at corresponding ends of the ropes or at corresponding opposite ends of the ropes by connecting means, and an electrical closed loop is formed by the conductive metal wires of the two ropes, the connecting means, and/or an input/output port included in one of the two transmitter-receivers.

12. The elevator according to claim 11, wherein the conductive metal wires of the ropes are coated with an insulated material.

13. An elevator comprising:
a plurality of ropes comprising conductive metal wires;
an elevator car suspended by the ropes for vertical movement in an elevator shaft;
a counterweight suspended by the ropes for vertical movement in the elevator shaft;
a sheave engaged with the ropes;
a motor for driving the sheave for rotation;
pulleys supported on upper and lower parts of the elevator shaft and on the elevator car to guide the ropes;
a control unit for controlling operation of the elevator car; and
two transmitter-receivers capable of transmitting and receiving signals through the conductive metal wires of the ropes;
wherein the conductive metal wires of the ropes are connected electrically at corresponding ends of the ropes or at corresponding opposite ends of the ropes by connecting means, an electrical closed loop is formed by the conductive metal wires of the two ropes, the connecting means, and/or an input/output port included in one of the two transmitter-receivers, and the conductive metal wires of the ropes are coated with an insulating material.

14. The elevator according to claim 13, wherein the plurality of ropes are arranged in a plane, and the transmitter-receivers are disposed opposite to the outermost rope.

15. The elevator according to claim 13, wherein the connecting means for electrically connecting the conductive metal wires of the two ropes includes two connectors connected to the conductive metal wires of the two ropes at ends of the two ropes, and capable of being connected together.

16. The elevator according to claim 13, wherein the connecting means for electrically connecting the conductive metal wires of the two ropes is a bend in a single rope serving as the two ropes.

17. The elevator according to claim 13, wherein the conductive metal wires of the ropes are coated with an insulating material, the conductive metal wires of the two ropes are connected electrically at corresponding ends of the two ropes by connecting means, and one of the transmitter-receivers is formed by electrically connecting the conductive wires of the two ropes at the corresponding other ends of the rope to the control unit.

18. The elevator according to claim 13, wherein the other transmitter-receiver on the elevator car is capable of contactless communication with the conductive metal wires of the rope.

19. The elevator according to claim 13, wherein the conductive metal wires of the ropes are coated with an insulating material, the conductive metal wires of the two ropes are connected electrically at corresponding ends of the two ropes by connecting means, and one of the transmitter-receivers is formed by electrically connecting the conductive wires of the two ropes at the corresponding other ends of the rope to the car control unit on the elevator car.

20. The elevator according to claim 19, wherein the other transmitter-receiver placed in the control unit is capable of contactless communication with the conductive metal wires of the rope.
